(19) United States
(12) Patent Application Publication
(10) Pub. No.: US 2008/0016296 A1
(43) Pub. Date: Jan. 17, 2008

(54) Data processing system

(76) Inventor: Kentaro Murayama, Osaka (JP)

Correspondence Address: MCDERMOTT WILL & EMERY LLP, 600 13TH STREET, NW, WASHINGTON, DC, 20005-3096, US

(21) Appl. No.: 11/819,368

(22) Filed: Jun. 27, 2007

(30) Foreign Application Priority Data
Jun. 29, 2006 (JP) 2006-179352

(51) Int. Cl. G06F 12/00

(52) U.S. Cl. 711/156; 711/E12.001

(57) ABSTRACT

A data processing system includes: a processor; a first memory for storing data which is accessed by the processor; a second memory having an area in which transferred data is stored; and a data control section for making a data transfer section transfer data from the first memory to the area in the second memory in accordance with an access request made by the processor, and storing area information indicating the data stored in the area. If data accessed by the processor is the data indicated by the area information, the data control section makes the processor access the second memory.

### CROSS-REFERENCE TO RELATED APPLICATION

This application claims priority under 35 U.S.C. §119 on Patent Application No. 2006-179352 filed in Japan on Jun. 29, 2006, the entire contents of which are hereby incorporated by reference.

### BACKGROUND OF THE INVENTION

The present invention relates to a data processing system incorporating a processor.

For a system LSI (large-scale integrated circuit) in a digital still camera, etc., large-capacity, relatively low-cost NAND flash memory has been often used. Since a processor cannot read a program or the like directly from NAND flash memory, the program or the like is transferred from the NAND flash memory to another memory, such as DRAM (dynamic random access memory), before the program or the like is read, which causes a latency time to occur in the processor.

In view of this, a microcontroller, which monitors data transfer by using a counter so that data already transferred can be read from the transfer destination memory so as to reduce a latency time in the processor, is disclosed in Japanese Laid-Open Publication No. 2002-297445, for example.

However, in the conventional microcontroller, if the transfer destination memory does not have sufficient capacity, all data cannot be transferred, and thus the processor has to transfer data when necessary. Furthermore, depending on the configuration of a program or data, the program or data is not necessarily transferred to the transfer destination in the order of addresses in the transfer source, and whether or not the program or data has been stored in the transfer destination cannot be determined by checking an address held in the counter. The processor thus has to control the area to which the program or data has been transferred, causing the load of the processor to be increased.

Moreover, data that has been transferred and then used by the processor must be removed efficiently from the transfer destination memory.

### SUMMARY OF THE INVENTION

It is therefore an object of the present invention to provide a data processing system which reduces, without causing an increase in the load of a processor, a latency time occurring when data is read from a memory, such as a flash memory, that cannot be accessed without a certain routine.

Specifically, an inventive data processing system includes: a processor; a first memory for storing data which is accessed by the processor; a second memory having an area in which transferred data is stored; a first access controller for controlling access to the first memory; a second access controller for controlling access to the second memory; a data transfer section for transferring data from the first memory to the second memory through the first and second access controllers; and a data control section for making the data transfer section transfer data from the first memory to the area in the second memory in accordance with an access request made by the processor, and storing area information indicating the data stored in the area, wherein if data accessed by the processor is the data indicated by the area information, the data control section makes the processor access the second memory.

In the inventive system, the data control section controls data transfer from the first memory to the second memory. And if data to which access has been requested by the processor is present in the second memory, the data control section makes the processor access the second memory. Thus, the processor does not need to control the data transfer.

In the data processing system, the first access controller preferably controls access to the first memory so that the processor can access data of the first memory irrespective of whether the first memory is a memory that cannot be accessed without a certain routine or the first memory is a memory that is accessible by an address received from an address bus.

Then, the processor can access the first memory regardless of the type of the first memory.

Also, the first access controller preferably allows the processor to access data of the first memory by using the same address space irrespective of whether the first memory is a memory that cannot be accessed without a certain routine or the first memory is a memory that is accessible by an address received from an address bus.

Then, regardless of the type of the first memory, the processor can access the first memory in the same manner. It is thus not necessary to perform different process for a different type of first memory.

In the data processing system, at the time of start-up of the data processing system, the data transfer section preferably automatically transfers data in a certain area in the first memory to the second memory.

Then, at the time of start-up of the data processing system, the data transfer section automatically transfers data in a certain area in the first memory to the second memory. By transferring the data or the like used at the time of start-up to the second memory, the data processing system can be started with no data-transfer-caused latency time occurring therein.

In the data processing system, the data control section preferably changes the size of the area in accordance with a request from the processor.

Then, since the data control section changes the size of the area in which transferred data is stored, the second memory can be used efficiently.

In the data processing system, the data transfer section preferably includes a buffer memory for storing therein data that is being transferred from the first memory to the second memory; and if the data to which access has been requested by the processor matches the data stored in the buffer memory, the data control section preferably makes the processor read that data from the buffer memory.

Then, the data transfer section can temporarily store, in the buffer memory, data being transferred, and the processor can access the stored data. It is thus possible to read data being transferred without waiting for the data transfer to be complete.

In the data processing system, the data control section preferably further transfers data in an area following an area where the data which has been accessed by the processor is stored, from the first memory to the second memory.

Then, the data control section also transfers data in the area following the area containing the accessed data, to the second memory. Thus, in a case where the processor makes access across one area and the area following the one area, a latency time caused by the transfer does not occur.

In the data processing system, the second memory preferably includes a plurality of said areas; and the data control section preferably determines, in accordance with a certain criterion, one of the plurality of areas that is to be overwritten, and instructs the data transfer section to overwrite the determined area.

Then, the utilization efficiency of the second memory is increased.

The data control section preferably makes the determination in accordance with a priority assigned to data stored in each of the plurality of areas.

The data processing system according to the present invention includes the data control section for controlling data transfer from the first memory to the second memory. Thus, no load is applied to the processor, and data transferred to and stored in the second memory can be read by directly accessing the second memory, thereby preventing occurrence of a latency time that would be otherwise caused by new transfer.

### BRIEF DESCRIPTION OF THE DRAWINGS

FIG. 1 is a block diagram illustrating the structure of a data processing system according to a first embodiment of the present invention.

FIGS. 2A, 2B, and 2C are explanatory views showing examples of logical memory maps in a flash memory 104, a tag memory, and a DRAM 108, respectively, according to the first embodiment.

FIG. 3 is a flowchart showing operation of a data control section 106 when a processor 101 requests an access.

FIGS. 4A, 4B and 4C are explanatory views showing examples of logical memory maps in a flash memory 104, a tag memory, and a DRAM 108, respectively, according to a second embodiment.

FIG. 5 is a flowchart showing the flow of process performed at the time of start-up of the data processing system according to the first embodiment.

FIG. 6 is a flowchart showing the flow of process performed at the time of start-up of a data processing system according to the second embodiment.

FIG. 7 is a block diagram illustrating the structure of a DMA controller 305.

FIG. 8 is a flowchart showing operation of a data control section 106 when a processor 101 requests an access in a third embodiment.

### DETAILED DESCRIPTION OF THE INVENTION

### First Embodiment

Hereinafter, a first embodiment of the present invention will be described with reference to the accompanying drawings.

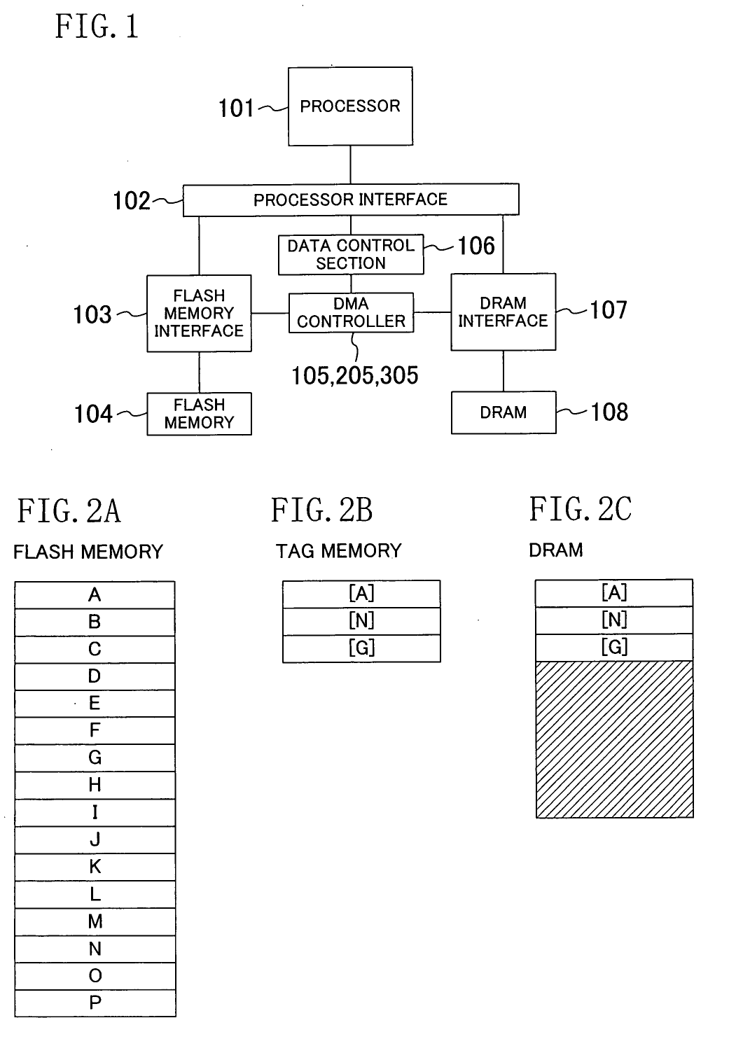

FIG. 1 is a block diagram illustrating the structure of a data processing system according to the first embodiment of the present invention. The data processing system shown in FIG. 1 includes a processor 101, a processor interface 102, a flash memory interface 103 as a first access controller, a flash memory 104 as a first memory, a DMA (direct memory access) controller 105 as a data transfer section, a data control section 106, a DRAM interface 107 as a second access controller, and a DRAM 108 as a second memory.

The flash memory 104 is a NAND flash memory, for example, and a certain routine is necessary to access data stored in the flash memory 104. Data stored in the flash memory 104 is transferred to the DRAM 108, before the data is read. The flash memory interface 103 accesses the flash memory 104 by using a certain signal.

The flash memory 104 does not have an address bus, and when reading is performed, a logical address is first written into an address register included in the flash memory 104. Thereafter, data is read sequentially starting from the data that the written logical address indicates. The flash memory interface 103 converts an address output from the processor interface 102 to the logical address.

The processor 101 includes a processor bus through which an address and read-request and write-request signals are transmitted. And the bus has a data bus through which actual data is transmitted. The processor 101 is connected to the processor interface 102 through this processor bus. The processor 101 outputs its request to access the flash memory 104, to the processor interface 102.

The processor interface 102 receives from the processor bus an address to which the processor 101 is trying to access, selects an appropriate one from the flash memory interface 103, the data control section 106, and the DRAM interface 107 in accordance with the received address, and accesses the selected member. The processor interface 102 outputs to the data control section 106 a signal giving notification that there was a request from the processor 101 to access the flash memory 104, and the address to be accessed.

The data control section 106 includes a tag memory which retains information (area information) indicating from which area in the flash memory 104 data is transferred to the DRAM 108. According to the address received from the processor interface 102 and the contents retained in the tag memory, the data control section 106 outputs to the DMA controller 105 a signal for controlling the DMA controller 105 in such a manner that data in an area in which the data to be accessed by the processor 101 is contained is transferred from the flash memory 104 to the DRAM 108. The data control section 106 notifies the processor interface 102 of the completion of the data transfer. The data control section 106 updates the contents in the tag memory each time the transfer is completed.

The starting address of the area in the flash memory 104 stored in the DRAM 108 is stored in the tag memory so that the area in the flash memory 104 whose data has been stored in the DRAM 108 can be determined. The data control section 106 compares the address provided by the processor interface 102 with the starting address of the area in the flash memory 104 held in the tag memory, thereby determining whether or not the data in the area in the flash memory 104 to which the processor 101 has requested to access has already been stored in the DRAM 108.

The tag memory stores therein not only the address indicating the area but also a priority for the data in that area. The priority may be determined by employing an algorithm similar to an algorithm used in a cache memory in the processor, for example, or may be determined by using a unique algorithm.

When the data control section 106 transfers data in response to a new access request made by the processor 101, the data control section 106 exercises control so that the data is written over one of the data areas in the DRAM 108 in which the lowest-priority data is stored, while areas storing high-priority data remain as they are.

It should be noted that the tag memory may be extended and some additional information may be written therein, so that the least-frequently accessed area is determined to be the area to be overwritten. Alternatively, the area to be overwritten may be simply selected in a random manner.

Also, the data in the area in the DRAM 108 that is overwritten may be written back into a corresponding area in the flash memory 104. Alternatively, the overwrite into the DRAM 108 may be simply carried out without performing the write-back into the flash memory 104.

According to the signal received from the data control section 106, the DMA controller 105 receives the data in the flash memory 104 from the flash memory interface 103 and transfers the received data to the DRAM interface 107.

The flash memory interface 103 accepts a request for access to the flash memory 104 from the processor interface 102 or from the DMA controller 105 and accesses the flash memory 104.

The DRAM interface 107 accesses the DRAM 108 using a certain signal. The DRAM interface 107 receives a request for access to the DRAM 108 from the processor interface 102 or from the DMA controller 105 and accesses the DRAM 108.

FIGS. 2A, 2B, and 2C are explanatory views showing examples of logical memory maps in the flash memory 104, the tag memory, and the DRAM 108, respectively, according to the first embodiment. In FIG. 2A, the entire region in the flash memory 104 is divided into 16 areas A to P by way of example. Those areas are determined based on logical address space and are equal in size.

In FIG. 2C, of the entire region in the DRAM 108, three area are allocated as areas in which data transferred from the flash memory 104 is stored. The size of each of those areas is the same as the size of each area in the flash memory 104. The other area in the DRAM 108 can be used for other purposes.

The tag memory in the data control section 106 retains information that indicates an area or areas in the flash memory 104 whose data has been transferred to and stored in the DRAM 108. That is, the tag memory retains information indicating any of the areas A to P or a state in which nothing is stored. FIG. 2B shows that data in the three areas A, N and G, for example, has been transferred from the flash memory 104 and then stored in the DRAM 108.

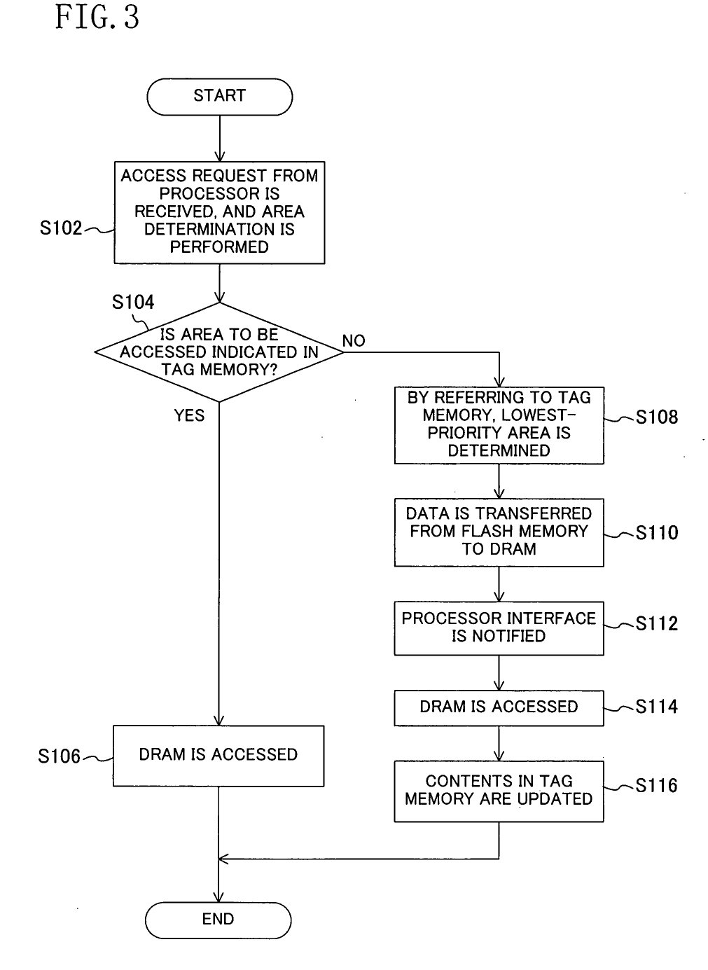

FIG. 3 is a flowchart showing operation of the data control section 106 when the processor 101 requests an access. In a step S102, upon receipt, from the processor interface 102, of a signal giving notification of a request by the processor 101 for access to the flash memory 104, the data control section 106 determines to which area in the flash memory 104 the access has been requested.

Next, in a step S104, the data control section 106 determines whether or not the tag memory indicates the area to be accessed. If the tag memory indicates the area in the flash memory 104 that is to be accessed by the processor 101, the process proceeds to a step S106, and if not, the process proceeds to a step S108. In the step S106, the processor 101 accesses the DRAM 108 through the processor interface 102 and the DRAM interface 107 and reads the data.

In the step S108, the data control section 106 refers to the tag memory and decides the lowest-priority data so as to determine the area in the DRAM 108 that is to be overwritten. In a step S110, the data control section 106 controls the DMA controller 105 so that the data to be accessed is transferred from the flash memory 104 and stored in the lowest-priority-data area in the DRAM 108 decided in the step S108.

In a step S112, the data control section 106 notifies the processor interface 102 of the completion of the data transfer to the DRAM 108. In a step S114, the processor 101 accesses the DRAM 108 through the processor interface 102 and the DRAM interface 107 and reads the data. In a step S116, the data control section 106 updates the contents in the tag memory.

Next, a description will be made of a case in which, at the time of start-up of the data processing system of this embodiment, the processor 101 reads a boot program from the flash memory 104. In this case, through the processor interface 102, the processor 101 makes a request for read access to data at the boot address stored in the flash memory 104. The processor interface 102 notifies the data control section 106 that the read request has been made.

As the data processing system is being booted up, nothing is held in the tag memory in the data control section 106. The data control section 106 thus determines that the data stored in the flash memory 104 that is to be accessed by the processor 101 is not present in the DRAM 108. Hence the data control section 106 controls the DMA controller 105 so that the data to be accessed by the processor 101, i.e., data in an area containing the data at the boot address, is transferred.

The DMA controller 105 transfers the data in the area containing the data to be accessed by the processor 101, from the flash memory 104 to the DRAM 108. When the transfer is complete, the data control section 106 updates the contents in the internal tag memory and notifies the processor interface 102 of the presence of the requested data in the DRAM 108. The processor 101 reads the data transferred from the flash memory 104, from the DRAM 108 through the processor interface 102 and the DRAM interface 107.

Next, the processor 101 makes a request to access the address following the boot address. As the data in the area containing the data at the boot address has already been transferred, the tag memory retrains the boot address. The data control section 106 thus determines that the data at the address to which the processor 101 has requested to access has already been stored in the DRAM 108 and notifies the processor interface 102 of the presence of the requested data in the DRAM 108. The processor 101 reads the requested data from the DRAM 108 through the processor interface 102 and the DRAM interface 107.

As described above, since the data control section 106 transfers data in accordance with an access request from the processor 101 and controls the transferred data, the processor 101 does not need to control addresses and areas, allowing the load of the processor 101 to be reduced. Furthermore, the flash memory interface 103 does not have to include memory, such as SRAM, used for performing the system start-up.

Also, a priority is assigned to data stored in the tag memory, one of the already used areas in the DRAM 108 is selected based on the priority, and transferred data is stored by overwriting the selected area. Then, the data processing system does not run out of areas in the DRAM 108 that are used for transfer.

Moreover, at the time of start-up of the data processing system, data in an area containing data at the boot address is transferred without an instruction from the processor 101. The processor 101 thus does not have to execute a transfer instruction program or the like.

### Second Embodiment

In a data processing system according to a second embodiment of the present invention, a flash memory interface 103 coverts an address instruction from a processor 101 in accordance with the type of a flash memory 104. Specifically, not only when the flash memory 104 is of such a type that data stored therein cannot be accessed without a certain routine, but also when the flash memory 104 is of such a type that data stored therein is accessible by an instruction provided through an address bus, the flash memory interface 103 allows the processor 101 to access the flash memory 104 by using the same address space.

When the flash memory 104 is of such a type that data stored therein is accessible by an instruction provided through an address bus, the flash memory interface 103 outputs an address received from the processor interface 102 to the flash memory 104 without converting the address.

In the data processing system of this embodiment, the DMA controller 105 in the data processing system of the first embodiment shown in FIG. 1 is replaced with a DMA controller 205. The DMA controller 205 includes a DRAM area setting register. By making settings in the DRAM area setting register under the control of the processor 101, the size of an area in the DRAM 108 used for transfer from the flash memory 104 can be set. The size of the area used for transfer is increased or decreased by the data control section 106 according to the value of the DRAM area setting register by units based on the area size in the flash memory 104.

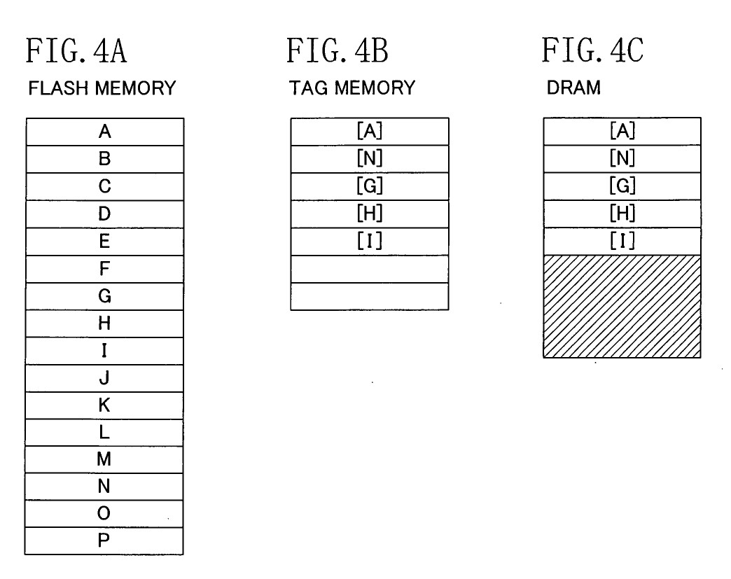

FIGS. 4A, 4B and 4C are explanatory views showing examples of logical memory maps in the flash memory 104, a tag memory, and a DRAM 108, respectively, according to the second embodiment. In FIGS. 4A, 4B and 4C, for example, of the areas in the DRAM 108, up to seven areas can be used for transfer from the flash memory 104.

In FIG. 4A, the entire region in the flash memory 104 is divided into 16 areas A to P by way of example. Those areas are determined based on logical address space and are equal in size. In FIG. 4C, of the entire region in the DRAM 108, five areas, for example, are set as areas in which data transferred from the flash memory 104 is stored. The size of each of those areas is the same as the size of each area in the flash memory 104.

The tag memory in the data control section 106 retains information that indicates an area or areas in the flash memory 104 whose data has been transferred to and stored in the DRAM 108. That is, the tag memory retains information indicating any of the areas A to P or a state in which nothing is stored. In FIG. 4B, the tag memory can hold information in up to seven areas, for example, but according to the information held in the tag memory, only five areas in the DRAM 108 are used for transfer and the remaining two areas are not used. FIG. 4B indicates that data in the five areas A, N, G, H and I, for example, has been transferred from the flash memory 104 and stored in the DRAM 108.

In this embodiment, at the time of start-up of the data processing system of this embodiment, the data control section 106 automatically transfers data in a certain area from the flash memory 104 to the DRAM 108 without receiving an access request from the processor 101.

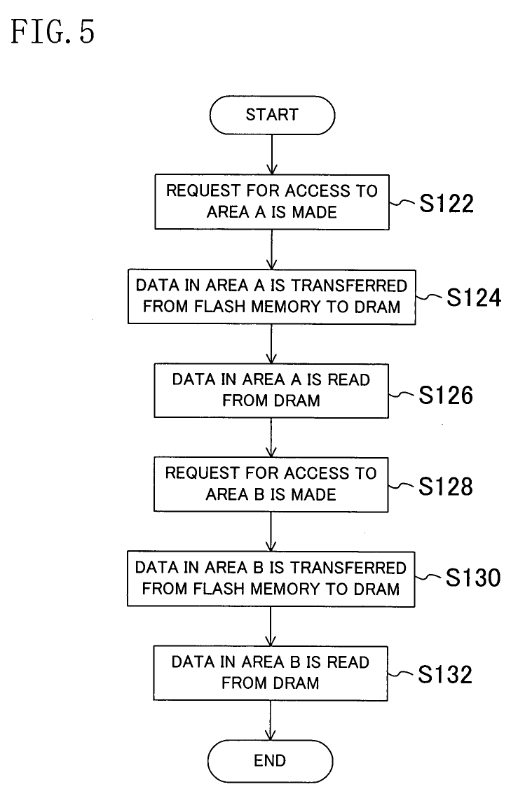

FIG. 5 is a flowchart showing the flow of process performed at the time of start-up of the data processing system according to the first embodiment. FIG. 5 shows a case, for example, in which, at the time of start-up of the data processing system, data is read from the flash memory 104 whose memory map is in the same state as that shown in FIG. 2A.

Once the process has started, in a step S122, the processor 101 requests an access to data in the area A in FIG. 2A stored in the flash memory 104. Next, in a step S124, the data control section 106 controls the DMA controller 105 so that the data in the area A is transferred from the flash memory 104 to the DRAM 108. Upon completion of the transfer, in a step S126, the processor 101 accesses the DRAM 108 through the processor interface 102 and the DRAM interface 107 and reads the data in the area A.

Subsequently, in a step S128, the processor 101 requests an access to data in the area B in FIG. 2A stored in the flash memory 104. Next, in a step S130, the data control section 106 controls the DMA controller 105 so that the data in the area B is transferred from the flash memory 104 to the DRAM 108. Upon completion of the transfer, in a step S132, the processor 101 accesses the DRAM 108 through the processor interface 102 and the DRAM interface 107 and reads the data in the area B.

Thus, in the case where, at the time of start-up of the data processing system, the processor 101 requests for access across the areas in the flash memory 104 and the data control section 106 performs the data transfer after receiving the access requests from the processor 101 as shown in FIG. 5, a latency time occurs, which corresponds to the period of time during which the data in the area B shown in FIG. 2A is transferred from the flash memory 104 to the DRAM 108.

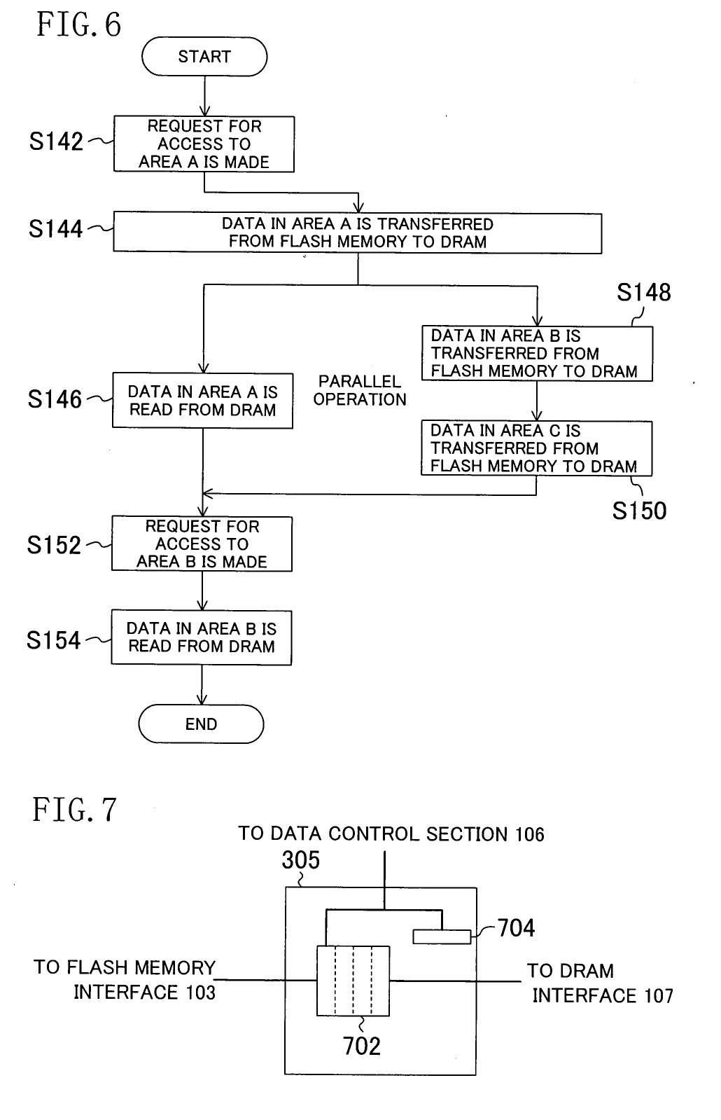

FIG. 6 is a flowchart showing the flow of process performed at the time of start-up of the data processing system according to the second embodiment. FIG. 6 shows a case, for example, in which, at the time of start-up of the data processing system, data is read from the flash memory 104 whose memory map is in the same state as that shown in FIG. 4A.

Once the process has started, in a step S142, the processor 101 requests an access to the area A in FIG. 4A stored in the flash memory 104. Next, in a step S144, the data control section 106 controls the DMA controller 205 so that the data in the area A is transferred from the flash memory 104 to the DRAM 108. Upon completion of the transfer, in a step S146, the processor 101 accesses the DRAM 108 through the processor interface 102 and the DRAM interface 107 and reads the data in the area A.

Steps S148 to S150 are carried out in parallel with the step S146. In the step S148, the data control section 106 controls the DMA controller 205 so that data in the area B in FIG. 4A is transferred from the flash memory 104 to the DRAM 108. In the step S150, the data control section 106 controls the DMA controller 205 so that data in the area C in FIG. 4A is transferred from the flash memory 104 to the DRAM 108.

In a step S152, the processor 101 requests an access to the area B. In a step S154, the processor 101 accesses the DRAM 108 through the processor interface 102 and the DRAM interface 107 and reads the data in the area B.

The process is performed as shown in FIG. 6, whereby, at the time of start-up of the data processing system, the data in the area B is automatically transferred from the flash memory 104 to the DRAM 108 while the processor 101 reads the data in the area A from the DRAM 108. Thus, a latency time, corresponding to the period of time during which the data in the area B is transferred, is not produced.

As described above, the flash memory interface 103 converts the address instruction from the processor 101 in accordance with the type of the flash memory 104, which allows the processor 101 to access the flash memory 104 by using the same address space regardless of the type of the flash memory 104. Thus, it is not necessary to use different software to access a different type of flash memory 104, and software does not have to be modified so as to cope with differences between the flash memories.

Moreover, since the DMA controller 205 has the DRAM area setting register, the DRAM 108 can be used according to the state of the system by increasing or decreasing the size of the area in the DRAM 108 that is used for transfer from the flash memory 104.

Furthermore, at the time of start-up of the data processing system, data in a certain area is automatically transferred from the flash memory 104 to the DRAM 108 without receiving an access request from the processor 101. Thus, even if the processor 101 requests for access across areas in the flash memory 104, no latency time occurs, resulting in a reduction in the system start-up time.

### Third Embodiment

In a data processing system according to a third embodiment of the present invention, the DMA controller 105 in the data processing system of the first embodiment shown in FIG. 1 is replaced with a DMA controller 305.

FIG. 7 is a block diagram illustrating the structure of the DMA controller 305. The DMA controller 305 is obtained by adding a buffer memory 702 and an address pointer register 704 to the DMA controller 105. For the buffer memory 702, a memory device is used which can be accessed with lower power consumption and at a higher speed than the DRAM 108 shown in FIG. 1.

The buffer memory 702 temporarily stores therein data which is transferred from the flash memory 104 shown in FIG. 1 to the DRAM 108. The address pointer register 704 stores therein an address in the flash memory 104 at which the data stored in the buffer memory 702 is located, and the value of the address pointer register 704 is updated each time data is transferred from the flash memory 104.

The data control section 106 shown in FIG. 1 accesses the buffer memory 702 and the address pointer register 704 and refers to the value stored in the address pointer register 704 to thereby determine the address in the flash memory 104 at which the data stored in the buffer memory 702 is located. If data to be accessed by the processor 101 shown in FIG. 1 matches the data stored in the buffer memory 702, the data control section 106 can read, from the buffer memory 702, the data being transferred, even before the data is stored in the DRAM 108.

Also, in this embodiment, in a case where data is transferred from the flash memory 104 to the DRAM 108 in response to an access request made by the processor 101, the data control section 106 transfers data in the next area together with the data requested by the processor 101.

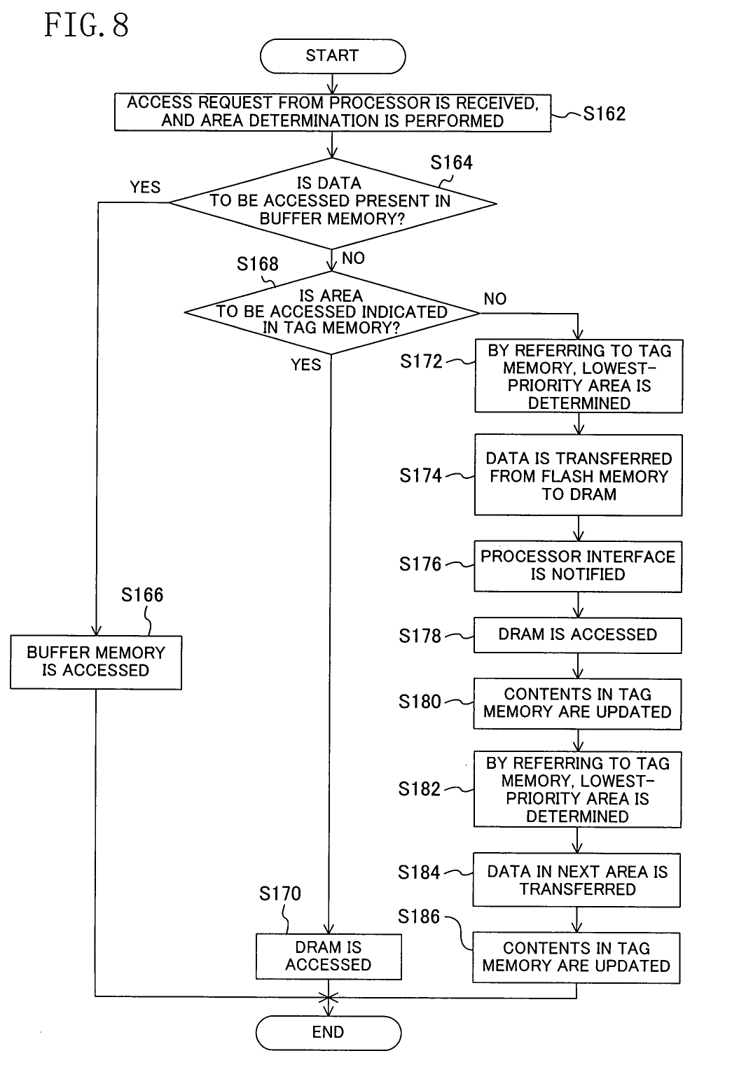

FIG. 8 is a flowchart showing operation of the data control section 106 when the processor 101 requests an access in the third embodiment. Once the process has started, in a step S162, upon receiving from the processor interface 102 a signal giving notification that the processor 101 has requested to access the flash memory 104, the data control section 106 determines to which area in the flash memory 104 the processor 101 has requested to access.

Next, in a step S164, the data control section 106 determines whether or not the data to be accessed is stored in the buffer memory 702. If the data that the processor 101 has requested to access is stored in the buffer memory 702, the process proceeds to a step S166, and if not, the process proceeds to a step S168.

In the step S166, the processor 101 reads the data from the buffer memory 702 through the processor interface 102 and the data control section 106. In the steps S168, S170, S172, S174, S176, S178, and S180, the same process is performed as in the steps S104, S106, S108, S110, S112, S114, and S116 shown in FIG. 3, respectively.

Next, in a step S182, the data control section 106 refers to the tag memory and decides the lowest-priority area so as to determine the area in the DRAM 108 that is to be overwritten. In a step S184, data in the area following the area that the processor 101 has requested to access is transferred from the flash memory 104 to the DRAM 108. In a step S186, the data control section 106 updates the contents in the tag memory.

As described above, the DMA controller 305 includes the buffer memory 702, and when data that the processor 101 has requested to access matches data stored in the buffer memory 702, the processor 101 reads the data from the buffer memory 702, whereby accesses to the DRAM 108 can be reduced. It is thus possible to reduce the time required to access the data and hence the power consumption.

It should be noted that when the data control section 106 transfers requested data, the data control section 106 may also transfer data in the area following the area in which the requested data is stored. Then, in a case where the processor 101 requests for access across the areas, no latency time occurs in transferring the data in the following area.

As described previously, the present invention, which can reduce a latency time occurring in data read from the flash memory without increasing the load of the processor, is applicable to general systems using NAND flash memory.

What is claimed is:

1. A data processing system, comprising:
a processor;
a first memory for storing data which is accessed by the processor;
a second memory having an area in which transferred data is stored;
a first access controller for controlling access to the first memory;
a second access controller for controlling access to the second memory;
a data transfer section for transferring data from the first memory to the second memory through the first and second access controllers; and
a data control section for making the data transfer section transfer data from the first memory, to the area in the second memory in accordance with an access request made by the processor, and storing area information indicating the data stored in the area,
wherein if data accessed by the processor is the data indicated by the area information, the data control section makes the processor access the second memory.

2. The data processing system of claim 1, wherein the first access controller controls access to the first memory so that the processor can access data of the first memory irrespective of whether the first memory is a memory that cannot be accessed without a certain routine or the first memory is a memory that is accessible by an address received from an address bus.

3. The data processing system of claim 2, wherein the first access controller allows the processor to access data of the first memory by using the same address space irrespective of whether the first memory is a memory that cannot be accessed without a certain routine or the first memory is a memory that is accessible by an address received from an address bus.

4. The data processing system of claim 1, wherein, at the time of start-up of the data processing system, the data transfer section automatically transfers data in a certain area in the first memory to the second memory.

5. The data processing system of claim 1, wherein the data control section changes the size of the area in accordance with a request from the processor.

6. The data processing system of claim 1, wherein the data transfer section includes a buffer memory for storing therein data that is being transferred from the first memory to the second memory; and
if the data to which access has been requested by the processor matches the data stored in the buffer memory, the data control section makes the processor read that data from the buffer memory.

7. The data processing system of claim 1, wherein the data control section further transfers data in an area following an area where the data which has been accessed by the processor is stored, from the first memory to the second memory.

8. The data processing system of claim 1, wherein the second memory includes a plurality of said areas; and
the data control section determines, in accordance with a certain criterion, one of the plurality of areas that is to be overwritten, and instructs the data transfer section to overwrite the determined area.

9. The data processing system of claim 8, wherein the data control section makes the determination in accordance with a priority assigned to data stored in each of the plurality of areas.
